(19) United States
(12) Patent Application Publication
(10) Pub. No.: US 2007/0157781 A1
(43) Pub. Date: Jul. 12, 2007

(54) Circular saw

(76) Inventors: Mike Wilson, Crook (GB); Neil Walmsley, Ferryhill (GB); Sion Netzler, Newton Aycliffe (GB)

Correspondence Address: Mehul R. Jani;Black & Decker Corporation, Mail Stop TW199, 701 E. Joppa Rd, Towson, MD, 21286, US

(21) Appl. No.: 11/634,539

(22) Filed: Dec. 6, 2006

(30) Foreign Application Priority Data
Dec. 8, 2005 (EP) 05111837.0

(51) Int. Cl. B23D 19/00

(52) U.S. Cl. 83/469

(57) ABSTRACT

A circular is provided which can operate in two modes. In a first mode, the circular saw operates in a conventional manner; in a second mode the circular saw can turned through 90° to operate in an undercutting mode, for undercutting a wall mounted door, for instance. To achieve this, the blade shroud comprises an outer surface facing away from the saw's motor housing which is flat for engagement with a floor surface or a guide rail. Advantageously, the outer surface might comprise a groove or channel arranged to cooperate with a guide rail rib.

### CROSS-REFERENCE TO RELATED APPLICATION

This application claims priority to European Patent Application No. EP 05111837.0, filed Dec. 8, 2005. The entire contents of that application are expressly incorporated herein by reference thereto.

### FIELD OF THE INVENTION

The present invention relates to an electrically powered manually operable power tool. In particular, the present invention relates to a circular saw which includes means to allow for additional operations such as undercutting.

### BACKGROUND OF THE INVENTION

Circular saws are well known power tools, generally used to cut straight edged cuts in wood, lumber or sheet metal. Typically, a circular saw comprises a housing mounted on a base plate. An electric motor and gearbox are disposed in the housing. An output spindle is mechanically coupled to the motor via the gearbox such that activation of the motor causes the spindle to rotate. A blade mount is attached to the output spindle for mounting a circular saw blade thereon. When attached to the spindle, the blade extends through an aperture in the base plate. A handle is provided for manual guidance of the saw.

The base plate may include a channel running along the underside of the base plate and parallel to the plane in which the blade rotates. The channel is arranged to engage with a guide rail which comprises a rib having the same width dimensions as the channel. Thus, when the saw is disposed on the guide rail and a portion of the rib is accommodated by the channel, the saw's direction of cut can be guided by the rail. Such an arrangement is disclosed in EP 0246417.

GB 1427700 describes a device for trimming the lower edge of a door. The device comprises a base member with support means carrying a motor for driving a rotary abrading tool about a vertical axis, and adjacent the base member. The base member engages with a floor next to a door and thereby enables the device to be moved along the floor alongside a mounted door for trimming its lower edge. The support means is a plate which is vertically adjustable by means of nuts threaded on studs secured to the base member.

GB 974674 describes a portable saw assembly which comprises a spindle mounted in a body portion having at least one handle and is, at one end, adapted to carry a circular saw blade and, at the other end, adapted to be connected to a power driving means, such as a portable electric drill. A gauge-base is adjustably mounted on the body portion for movement towards and away from the blade, the gauge-base serving to support the assembly for movement over a supporting surface with the blade within a minimum clearance distance of the surface.

U.S. Pat. No. 4,273,016 describes a template used in assisting in cutting off a bottom of a door so that the bottom of the door is parallel with the floor, but is raised a sufficient distance from the floor to allow a floor covering to be installed on the floor has an elongated member sized to fit across the width of one of the face surfaces of the door.

U.S. Pat. No. 4,233,954 describes a portable concrete pile cutting device which comprises a support collar adapted to be removably mounted in supported annular location about a concrete pile, at least one pile cutting assembly mounted for reciprocation on the collar, and means located on the collar for the support of the pile cutting assembly.

Devices described in the prior art require means for mounting, or holding a saw onto the object being cut.

Embodiments of the present invention provide a manually operated hand held circular saw which can operate in a conventional manner, and which is easily adapted to operate for undercutting doors, or the like. Thus, a circular saw is provided wherein the blade shroud has a flat outer surface facing away from the motor housing and on which the saw can rest, either on the floor adjacent a door, or on a guide rail disposed on the floor.

### BRIEF SUMMARY OF THE INVENTION

More specifically, the present invention provides a manually operated electrically powered circular saw, comprising an electric motor disposed in a housing, said motor being mechanically coupled to a spindle having an axis of rotation, a blade clamp attached to the spindle and being arranged to clamp a saw blade whereby, during use, a saw blade disposed in the clamp can rotate in a plane of rotation, a shroud for accommodating the blade clamp and a portion of a saw blade, and a base plate arrange to engage with a workpiece during use, said base plate comprising an opening through which a portion of the saw blade can extend to engage the workpiece, wherein the shroud comprises an outer surface facing away from the motor housing, said outer surface being flat and parallel to the plane of rotation thereby allowing the saw to operate in an undercutting mode when the outer surface is rested on a floor surface next to a door.

In the undercutting mode, the saw can be orientated on the side of the shroud, that is resting on the outer surface of the shroud, such that the base plate is vertical and saw blade can extend from the base plate and rotate in a horizontal plane (when the shroud is resting on a horizontal surface, such as a floor). In this manner, for example, a circular saw embodying the present invention can be disposed on the floor next to a door and orientated in a way which allows the saw to undercut the door. Furthermore, the phrase undercutting mode is not meant to limit the scope of operation to just undercutting doors; other applications will be envisaged by the skilled person, such as trimming a skirting board or a dado rail disposed on a wall, for example.

Preferably, the shroud comprises a guide means arranged to couple with a guide rail disposed on a planar surface such that, when the saw is disposed on a guide rail with the guide means coupled to a guide rail, the plane of rotation is parallel with the planar surface. Thus, the saw embodying the present invention can be located on a guide rail for improved accuracy of cutting.

Preferably, the guide means comprises a channel disposed in the outer surface for engagement with a cooperating rib disposed on a guide rail. Thus, the saw can be located on, and guided by a conventional guide rail.

Preferably, the channel extends along the outer surface in a longitudinal direction such that either end of the channel is open. Thus, the saw is free to move along the length of the guide rail, during use.

Preferably, the housing is pivotably coupled to the base plate. Thus, the depth of cut achieved by the blade is adjustable.

Preferably, a resilient member is arranged to urge the housing away from the base plate. Thus, the present invention can provide a plunge-action circular saw thereby improving the ease of use of the saw.

Preferably, the shroud comprises inner and outer portions, the outer surface is disposed on the outer portion of the shroud, and said outer portion is moveable between a first and second position with respect to the housing. Thus, a means of adjusting the position of the saw blade relative to the floor or guide rail is provide for the saw, when operating in the door cutting mode. In other words, the distance between the plane of rotation and the outer surface can be adjusted.

Preferably, the outer portion is disposed on a guide member arranged such that the outer surface is parallel to the plane of rotation when the outer surface is in either the first or second position. The guide member acts to maintain the orientation of the outer surface as it is moved between the first and second positions thereby preventing, or aiding in the prevention of the saw blade becoming misaligned with the plane of the outer surface.

Preferably, a bellows member is disposed between the inner and outer portions and the shroud. Alternatively, the inner and outer portions of the shroud can be arranged to overlap thereby accommodating a saw blade disposed on the blade clamp when the outer portion of the shroud is in the first or second position. The bellows member or overlapping portions of the shroud act to retain any saw dust or debris within the shroud; the shroud remains a closed hood over the saw blade.

Preferably, a shim having a predetermined thickness is provided, said shim being disposable, either between the inner and outer portions of the shroud, or between the outer surface and a guide rail, or between the guide rail and floor surface on which the rail is disposed. The shim provides an alternative means of adjusting the distance between the plane of rotation and the outer surface, as described above.

Preferably, the base plate comprises a channel arranged to cooperate with a guide rail. Thus, the guide rail can be used conventionally and in the door cutting modes.

### BRIEF DESCRIPTIONS OF THE DRAWINGS

Embodiments of the present invention are now described by way of example, and with reference to the accompanying drawings.

FIG. 1 is a schematic diagram of a circular saw embodying the present invention and operating in a conventional manner;

FIG. 2 shows the circular saw of FIG. 1 operating in a door cutting mode;

FIG. 3 shows a schematic diagram of a portion of a saw embodying the present invention;

FIG. 4 shows a schematic diagram of a portion of an alternative saw embodying the present invention; and

FIG. 5 shows a schematic diagram of an embodiment of the present invention undercutting a door.

### DETAILED DESCRIPTION OF THE INVENTION

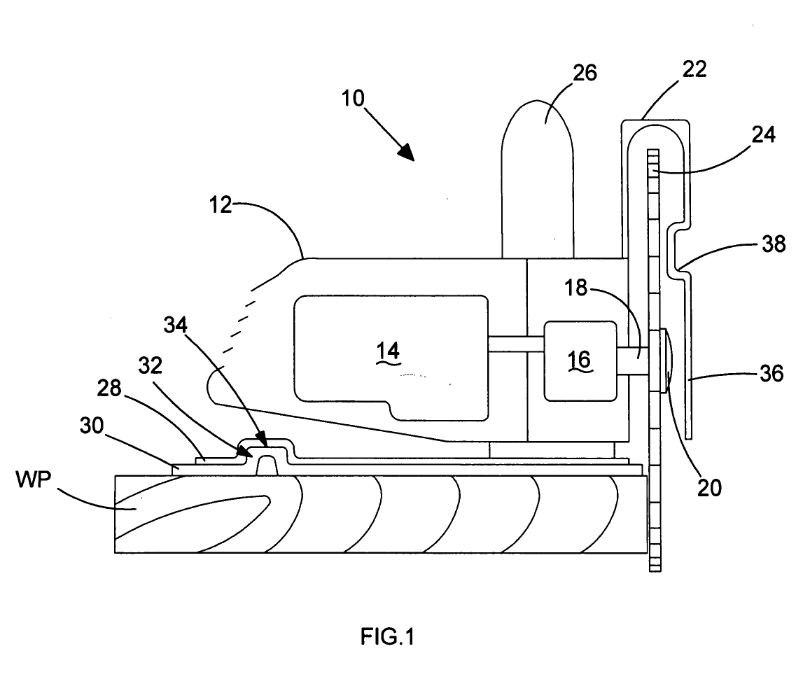

Referring to FIG. 1, a circular saw 10 embodying the present invention is shown. The saw comprises a housing 12 having a motor 14 and a gearbox 16 disposed therein. The motor is coupled to an output shaft 18 via the gearbox. A blade clamp 20 is disposed on the end of the output shaft extending inside a shroud or cowl 22. A circular saw blade 24 is shown attached to the spindle by the blade clamp. A handle 26 is provided to aid the user in operating the saw. A switch is disposed at a convenient location so that the user can activate the electric motor 14 while gripping the handle. The saw 10 further comprises a base plate 28 which is coupled to the housing and/or the cowl 22. The motor can be powered by either electricity or by a battery pack.

FIG. 1 shows the saw embodying the invention being disposed in a conventional manner on a workpiece WP. The saw is arranged to cut the workpiece. A guide rail 30 is disposed between the base plate 28 and the workpiece WP. The guide rail comprises a longitudinal rib 32 which is arranged to cooperate with a channel 34 in the base plate. Thus, the location and direction of the cut intended to be made on the workpiece by the saw is determined by the position of the guide rail on the workpiece. Of course, it is not necessary to use a guide rail in this manner—the operator might prefer to cut the workpiece without using a guide rail.

The blade shroud 22 comprises an outer surface 36 which faces away from the motor housing. This surface is substantially flat. By “substantially flat” we mean that the surface is arranged to have a flat profile, although there might be patterns or surface decoration (such as profiled or embossed trademark) on the surface; the surface 36 has a general configuration that is flat or planar.

A shroud channel 38 is disposed in a longitudinal direction on the shroud outer surface 36. The shroud channel 38 has the same cross-sectional dimensions as the channel 34 in the base plate. Thus, the shroud channel can accommodate and cooperate with the guide rail rib 32. In the configuration shown in FIG. 1, the channel 38 in the shroud extends along the whole length of the shroud 22 in a direction perpendicular to the intended cut direction and parallel with a plane defined by the base plate.

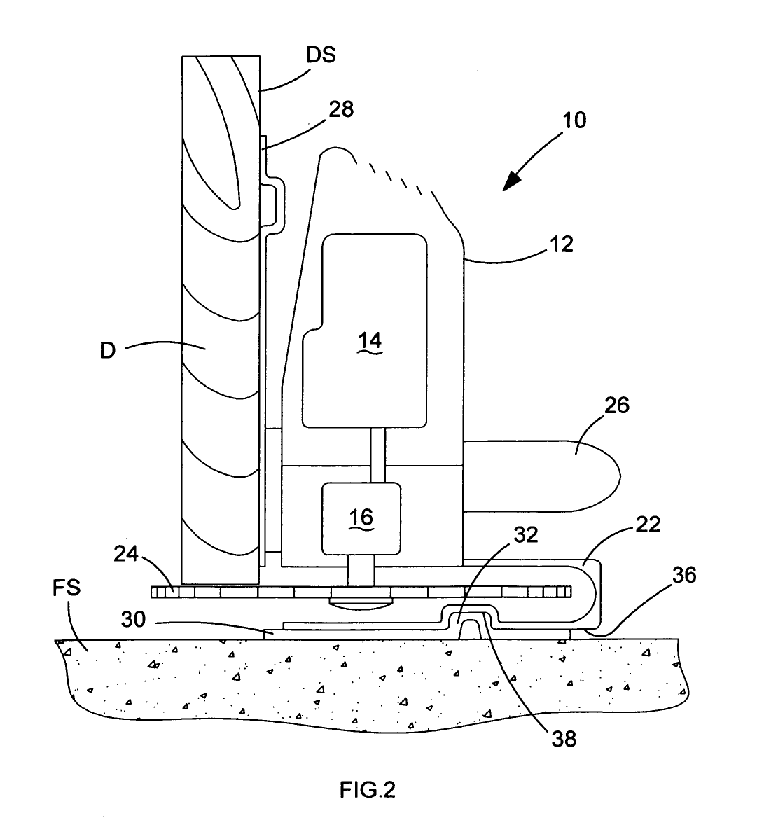

FIG. 2 shows the circular saw of FIG. 1 in a so-called door cutting mode. Of course, this mode of operation is not limited to undercutting doors; this figure merely illustrates one application, that of cutting doors.

Referring to FIG. 2, the circular saw 10 is disposed on a floor surface FS adjacent to a door D. The door is mounted to a wall by hinges, in the usual manner. In this configuration it can be seen that the saw blade is now orientated horizontally and parallel to the floor surface. The outer surface 36 of the shroud 22 is disposed on the floor FS or a guide rail 30 disposed on the floor. The channel 38 is shown in cooperation with the rib of the guide rail. As a result, the saw can be guided along the surface DS of the door when the guide rail is arranged parallel to the door's surface DS. Furthermore, the operator can arrange the (now) vertical base plate 28 to engage with the door's surface so that the base plate can act as a further guiding means.

Thus, the blade can cut a portion of the door closest to the floor along the width of the door. Such an operation is known as undercutting. The operator is therefore able to remove a lower portion of the door to provide a greater gap between the base of the door and the floor surface without removing the door from the door frame. As a result, a gap between the floor and underside of the door can be increased to allow a carpet to be laid under the door, for instance.

Saw dust or debris is often ejected from or extracted through an aperture disposed in the blade shroud. In the embodiments of the present invention, any such aperture (if such an aperture is provided) should be disposed on an inner surface of the shroud facing the housing 12. Alternatively, the aperture can be arranged at the rear of the shroud but in manner which does not cause a portion of the aperture or aperture housing to protrude from the flat planar outer surface.

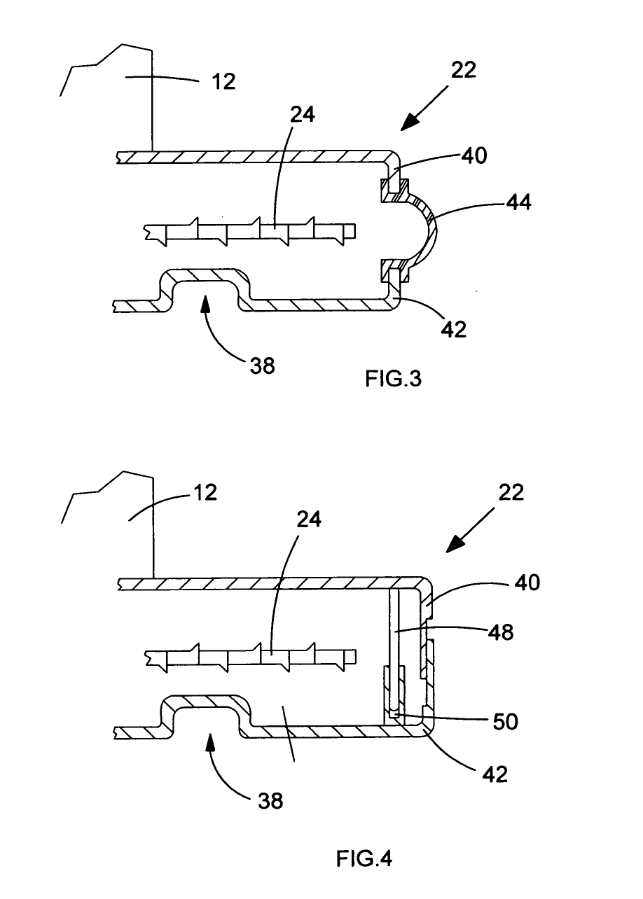

Referring now to FIG. 3, a portion of the blade shroud 22 is shown. The shroud comprises inner 40 and outer 42 components which are spaced apart and joined together by a rubber bellows 44 or resilient expansion means. The inner portion of the shroud is mounted to the housing.

The bellows allow relative movement of the inner and outer portions. As a result, the distance between the plane of rotation of the saw blade and the floor surface can be adjusted. Furthermore, the bellows should not prevent any debris from escaping the shroud in an unwanted manner—the shroud remains a closed hood accommodating a portion of the saw blade, save for any debris extraction means.

In an alternative arrangement, shown in FIG. 4, the inner and outer shroud portions comprise over lapping elements, which provide the same advantages and/or effects described above.

Both embodiments shown in FIGS. 3 and 4 should also comprise a means for maintaining the inner and outer component parts of the shroud in alignment with one another. This is necessary in order to maintain the alignment of the outer surface, upon which the saw rests during an undercutting operation, with the plane in which a saw blade rotates during use. If this alignment is not kept with a degree of accuracy, the resulting cut to the workpiece can be undesirably rough-edged. This results in further work having to be done to the workpiece in order to make good the rough-edged cut. Such alignment means might take the form of a pin 48 disposed on the inner portion 40 of the shroud and cooperating with a bore 50 disposed on the outer portion 42 of the shroud. Two or more of these means might be necessary to ensure accuracy of alignment. Similar alignment devices will be envisaged by the skilled person.

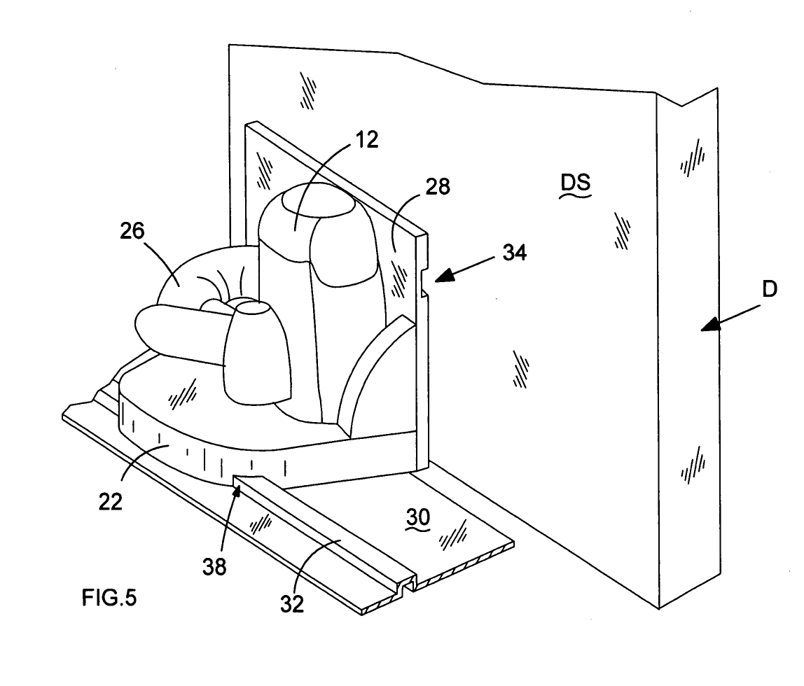

Referring to FIG. 5, a circular saw, having a plunge-action cut, is shown disposed on a guide rail. The rail is lying parallel to the door's surface DS and the base plate of the saw is in engagement with the door's surface. Thus, the saw is guided by both the guide rail and the door surface.

Alternative arrangements of the embodiments described above will be envisaged by the skilled person. For instance, the shroud's outer surface might not require a channel. An alternative embodiment might include low-friction strips of material partially embedded in the outer surface. Such material might comprise nylon or PTFE. A shim having predetermined thickness could be used to set the distance between the blade's axis of rotation and the surface on which the saw is disposed when operating in an undercutting mode. The shim can be disposable between the shroud and guide rail, or between the guide rail and floor surface. Several shims of varying and/or different thickness can be supplied thereby providing a means to adjust the cut height from the floor within a combination of distances.

What is claim is:

1. A manually operable electrically powered tool, comprising:
an electric motor disposed in a housing, said motor being mechanically coupled to a spindle having an axis of rotation;
a blade clamp attached to the spindle and being arranged to clamp a saw blade in a manner allowing the saw blade to rotate in a plane of rotation;
a shroud for accommodating the blade clamp and a portion of a saw blade, said shroud comprising an outer surface facing away from the motor housing; and
a base plate arrange to engage with a workpiece during use, said base plate comprising an opening through which a portion of the saw blade can extend to engage the workpiece,
wherein the shroud outer surface is substantially flat and substantially parallel to the plane of rotation thereby allowing the saw to operate in a horizontal cutting mode when the saw is set on the shrouds outer surface.

2. The tool of claim 1, wherein the shroud comprises a guide arranged to couple with a guide rail disposed on a planar surface such that, when the saw is disposed on a guide rail with the guide coupled to a guide rail, the plane of rotation is parallel with the planar surface.

3. The tool of claim 2, wherein the guide comprises a channel disposed on the outer surface to cooperate with a rib disposed on a guide rail.

4. The tool of claim 3, wherein the channel extends along the outer surface in a longitudinal direction such that either end of the channel is open.

5. The tool of claim 1, wherein the housing is pivotably coupled to the base plate.

6. The tool of claim 5, further comprising a resilient member arranged to urge the housing away from the base plate.

7. The tool of claim 1, wherein the shroud comprises inner and outer portions, the outer surface is disposed on the outer portion of the shroud, and said outer portion is moveable between a first and second position with respect to the housing.

8. The tool of claim 7, wherein the outer portion is disposed on a guide member arranged such that the outer surface is parallel to the plane of rotation when the outer surface is in either the first or second position.

9. The tool of claim 7, further comprising a resilient member disposed between the inner and outer portions of the shroud.

10. The tool of claim 7, wherein the inner and outer portions of the shroud overlap thereby accommodating a saw blade disposed on the blade clamp when the outer portion of the shroud is in the first or second position.

11. The tool of claim 7, further comprising a shim having a predetermined thickness, said shim being disposable between the inner and outer portions of the shroud.

12. The tool of claim 7, further comprising a shim having a predetermined thickness, said shim being disposable between the outer surface and a guide rail.

13. The tool of claim 7, further comprising a shim having a predetermined thickness, said shim being disposable between the guide rail and a surface having the guide rail disposed thereon.

14. A manually operable electrically powered circular saw, comprising:
a housing having a motor disposed therein, said motor being mechanically coupled to a spindle having an axis of rotation;
a blade clamp attached to the spindle and being arranged to clamp a saw blade in a manner allowing the saw blade to rotate in a plane of rotation; and
a blade shroud arranged to accommodate a portion of saw blade disposed on the spindle,
wherein the blade shroud has an outer surface facing away from the housing, said outer surface being substantially flat.
